(19) United States
(12) Patent Application Publication
(10) Pub. No.: US 2014/0212637 A1
(43) Pub. Date: Jul. 31, 2014

(54) METHOD FOR FORMING BONDED STRUCTURES AND BONDED STRUCTURES FORMED THEREBY

(71) Applicants: Andrew John Syvret, Warwick (GB); Sylvain Pujol, Warwick (GB)

(72) Inventors: Andrew John Syvret, Warwick (GB); Sylvain Pujol, Warwick (GB)

(21) Appl. No.: 14/006,031

(22) PCT Filed: Mar. 19, 2012
(86) PCT No.: PCT/GB12/00252

§ 371 Date: Mar. 19, 2014

(30) Foreign Application Priority Data
Mar. 18, 2011 (GB) 1104675.2

(51) Int. Cl. B29C 65/52; B29C 65/54; B32B 7/12

(52) U.S. Cl. CPC B29C 65/52; B32B 7/12; B29C 65/542
USPC 428/201; 156/60; 156/285; 264/261

(57) ABSTRACT

A method of forming a bonded structure (10), such as for use in an automobile structure, comprises providing a first substrate (14) and a second substrate (16), and adding an adhesive region between the substrates, wherein the adhesive region has a first adhesive portion (18) and a second adhesive portion (12), and curing the first adhesive portion more quickly than the second adhesive portion, the method including positioning the substrates relative to one another and injecting the adhesive between said substrates to form an adhesive region while holding the substrates relative to one another.

The present invention relates to methods of forming bonded structures. It also relates to bonded structures, vehicles including such bonded structures, and methods of manufacturing vehicles, such as automotive vehicles, land vehicles and motor cars. The invention may also be applied in fields outside the automotive arena.

A known method of forming a bonded structure comprises providing a substrate, applying adhesive to the substrate, and then moving a second substrate into contact with the adhesive in order to bond the substrates together. A problem with this method is that with complex joint geometries, it is often difficult to control the amount of adhesive to be used and adhesive wastage may occur when adhesive may be squeezed from between the substrates. The process can also be time consuming, costly and a potential bottleneck in a production line. There are also health and safety issues due to excess spew during parts handling.

The present invention aims to alleviate at least to a certain extent at least one of the problems of the prior art, or to provide a useful or improved bonding method and bonded structure.

According to a first aspect of the invention there is provided a method of forming a bonded structure comprising:
providing a first substrate and a second substrate, and adding an adhesive region between the substrates, wherein the adhesive region has a first adhesive portion and a second adhesive portion, and curing the first adhesive portion more quickly than the second adhesive portion.

The second adhesive portion may be applied to at least one of the substrates before, substantially simultaneously with or after the first adhesive portion. The first adhesive portion does not need to harden or cure fully before the second adhesive portion is applied.

This aspect of the invention is highly advantageous because accurate and fast bonding may be achieved with the bond still having excellent characteristics. For example, the second adhesive portion may be formed over the majority or substantial majority, such as at least 50%, 75%, 85%, 90% or 95%, of the area of the adhesive region in contact with at least one of the substrates and/or the volume of adhesive applied, about 80 to 99% or 92 to 97% being typical in some examples, about 95% being one example. This second adhesive portion may have excellent properties once cured, even though it may only be able to cure at a relatively slow rate. The first adhesive portion, which may comprise a minority of the adhesive of the adhesive region may cure relatively quickly such that the bonded structure may relatively quickly be moved on to a next station on a production line. Accordingly, the bonded structure may be moved, e.g. along a production line, before the second adhesive portion has fully cured. Production may be quick, but the end product may have excellent characteristics and adhesive parameters once the second adhesive portion, which may be relatively slow to cure relative to the first adhesive portion, has cured.

The adhesives of the first and second adhesive portions may have different chemical compositions to one another, either due to the use of different constituent components or due to the use of different ratios of constituent components, e.g. resin and hardener/catalyst.

Using rivets instead of a fast cure adhesive (the first adhesive portion) has be considered by the present inventor too, but the use of the fast cure adhesive can provide a significantly better cosmetic result where one of the substrates has an exposed surface (such as a body panel) in a finished product incorporating the bonded structure, and there are other potential advantages including water leakage/ingress and the maintenance of structural integrity of the substrates. There is also an advantage that the first adhesive portion (e.g. a relatively fast cure adhesive) allows less movement between the substrates than using rivets or other mechanical fasteners.

The first adhesive portion may comprise a fast cure adhesive, e.g. one which cures faster than the second adhesive portion. The second adhesive portion may comprise a slow cure adhesive, e.g. one which cures more slowly than the first adhesive portion. The first adhesive portion may comprise adhesive at least part of which is a faster cure adhesive than at least part of adhesive of the second adhesive portion. The first adhesive portion may be comprised of adhesive applied in a distinct region of adhesive extending fully between the first and second substrates. Alternatively, or in addition, the first adhesive portion may be formed by adding, such as by spraying, a component such as a catalyst component (e.g. additional or excess catalyst), to an adhesive laid down with the second adhesive portion. The first adhesive portion may thereby be formed in a localised area with the component, e.g. excess catalyst, arranged to increase cross-linking and thereby the speed of cure in a localised area.

The method preferably includes moving the bonded structure. The method may include moving the bonded structure once the first adhesive portion is substantially cured, so that relative movement between the first and second substrates does not easily occur. The method may include moving the bonded structure before the second adhesive portion has completed curing. Thus the first adhesive portion may support the bonded structure during the moving and quick production may be achieved even though the second adhesive portion has not cured at the time of movement.

The method may include providing the second adhesive portion with adhesive having a performance parameter superior to adhesive in the first adhesive portion. The performance parameter may be, for example, one or more of ultimate tensile strength, Young's modulus, yield strength, compressive strength, impact strength, fracture toughness, fatigue performance, vibration resistance and/or damping, chemical resistance, high or low temperature resistance and thermal shock resistance. Accordingly a joint of very high performance may be provided in a fast production process even when the adhesive of the second adhesive portion can only cure relatively slowly.

According to a second aspect of the invention there is provided a method of forming a bonded structure comprising providing a first substrate and a second substrate and applying adhesive to surfaces of the substrates, wherein the method including positioning the substrates relative to one another and injecting the adhesive between said surfaces to form an adhesive region while holding the substrates relative to one another. This method has the advantage that adhesive is not easily wasted such as by being unnecessarily squeezed out from between the substrates. Since the substrates are held, it is relatively easy to apply the right amount of adhesive and in the right places.

A number of features which may be used when carrying out one or both of the above aspects of the invention will now be described.

The method may include holding one or both of the first and second substrates in a jig while the adhesive region is applied. The method may include holding the first and second substrates spaced apart in a fixed configuration relative to one another with a gap therebetween and injecting the adhesive region into the gap.

At least one of the first and second substrates may have a substantially flat surface at the adhesive region to which the adhesive region is applied. The first and second substrates may both have said substantially flat surfaces, which may face one another. Said surfaces may be parallel to one another and spaced apart by a gap which is at least partially filled by the adhesive region which may reach across between and contact both said surfaces of the substrates. The gap may be constant, e.g. with flat substrate surfaces, or may vary somewhat in some said bonded structures. The gap may be constant at or vary between about 1 mm to 10 mm or so wide, 2 to 8 mm being typical, about 4 to 6 mm being envisaged for some examples.

The method may include injection of at least part of the adhesive region through a hole formed through one of the substrates. Alternatively, or in addition, injection may be into a gap between the substrates at an edge region thereof.

The method may include applying at least part of the adhesive(s) of the adhesive region through a nozzle. At least one component of the adhesive(s) of the adhesive region may be heated prior to application to the substrate(s). The method may include providing a suction device or other device for holding the nozzle in place while adhesive is applied through it.

Each adhesive portion may in some preferred embodiments comprise a two-part adhesive comprising resin and hardener (or catalyst).

The method may include applying a vacuum around at least part of the adhesive region in order to assist in moving adhesive components into place.

The method may include providing a spacer, such as a raised area, ridge or spot on at least one of the substrates, for providing a spacing gap between the substrates.

The method may involve configuring the fast cure adhesive/first adhesive portion as a perimeter into the inside of which the slow cure adhesive/second adhesive portion may be injected. The first adhesive portion may thus comprise a seal around the second adhesive portion, e.g. as a perimeter, to prevent leakage while the second adhesive portion cures fully, and potentially also while the second adhesive portion is injected/ applied into place. Alternatively, or in addition, the first adhesive portion may be applied as individual and mutually spaced apart zones or “blobs”.

At least one of the substrates may comprise a metal material such as an aluminium alloy or an anodised aluminium material, or a composite material such as a material comprising fibres and resin or a laminated composite, or plastics. The bonded structure may include more than two said substrates which are joined together by adhesive.

A further aspect of the invention comprises a bonded structure formed in accordance with one or both of the aforementioned aspects of the invention.

A further aspect of the invention comprises a bonded structure comprising a first substrate and a second substrate bonded together by an adhesive region, wherein the adhesive region includes a first adhesive portion and a second adhesive portion, the first adhesive portion containing faster cure adhesive than the second adhesive portion.

The bonded structure in these two last aspects of the invention may comprise an automotive structure, or another type of component structure. The bonded structure may comprise, for example, an automotive bodyshell assembly, chassis assembly, structural assembly, pillar, post or crash load absorption structure, or a panel structure, such as a door, roof, tonneau bow member, wing, fender, trunk/boot lid, hood/bonnet structure, ducting e.g. a cooling duct, container, e.g. a fuel tank, or an aerodynamic wing, diffuser, spoiler or air dam.

A further aspect of the invention comprises an automotive vehicle or a land vehicle, such as a motor car, which includes a bonded structure as set out above in accordance with at least one above aspect of the invention.

A further aspect of the invention comprises a method of manufacturing an automotive vehicle or a land vehicle, such as a motor car, which includes the step of forming a bonded structure as set out above in a method of forming a bonded structure in accordance with an above aspect of the invention.

The present invention may be carried out in various ways and a number of preferred embodiments of forming bonded structures in accordance with the invention will now be described by way of example only and with reference to the accompanying drawings, in which:

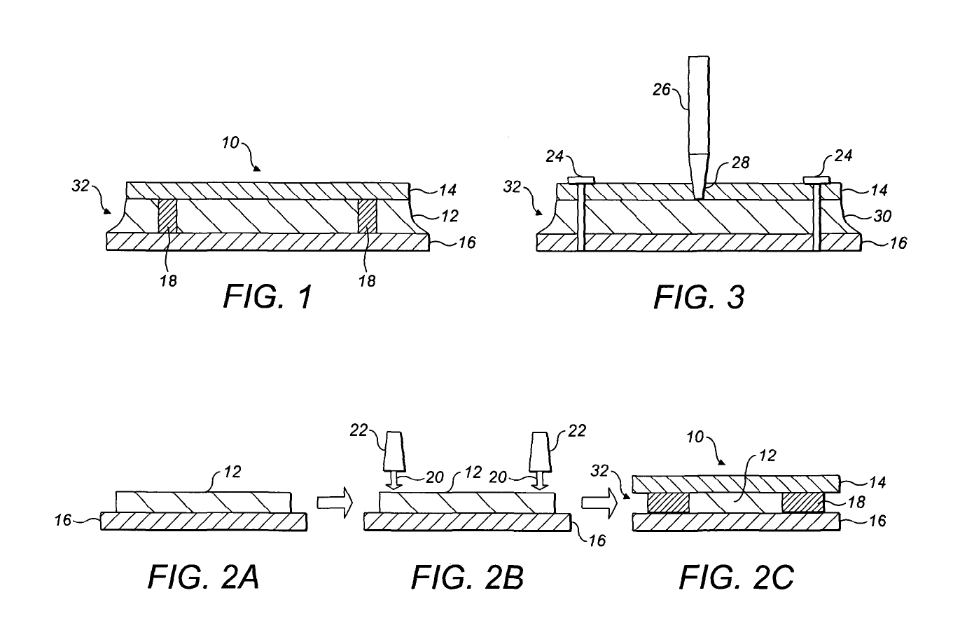

FIG. 1 schematically shows substrates and an adhesive portion formed in accordance with a first preferred embodiment of the present invention;

FIGS. 2A, 2B and 2C schematically show three stages in a second preferred embodiment of a method of forming a bonded structure in accordance with the invention; and

FIG. 3 schematically shows an injection nozzle, substrates, adhesive and mechanical fasteners in position while carrying out a third preferred embodiment of a method of forming a bonded structure in accordance with the invention.

In the preferred embodiment of FIG. 1, a method of forming a bonded structure 10 in accordance with the invention, which is to be used as an automotive component in a motor car, a robot (not shown) applies a slow cure adhesive 12 to parts comprising first and second substrates 14, 16. The slow cure adhesive 12 may first have been applied to one or both of the substrates 14, 16. The substrates 14, 16 are then moved to a position near assembly stations (not shown) incorporating jigs (not shown). The substrates 14, 16 are then placed in a jig (not shown) or jigs (not shown) and a fast cure adhesive 18 is added, either manually by a manual worker or automatically by a robot, to predefined positions and in predefined amounts. The joint of the first and second substrates 14, 16 is then closed and the jig/jigs remain in place holding the two substrates 14, 16 in position relative to one another until the fast cure adhesive 18 has cured sufficiently that the bonded structure 10 can be moved along a production line (not shown) without the substrates 14, 16 moving relative to one another or any significant movement of the adhesive 12, 18. The jigs (not shown) are then removed and the parts (as the bonded structure with the configuration shown in FIG. 1) are then moved on to the next station (not shown) on the line. The bonded structure 10 can therefore very advantageously continue down the line while the slow cure adhesive 12 is still curing. The slow cure adhesive may have performance characteristics or parameters which, once it has cured, are superior to those of the fast cure adhesive. For example, the slow cure adhesive may have superior ultimate tensile strength, Young's modulus, yield strength, compressive strength, impact strength, fracture toughness, fatigue cycling performance, vibration resistance, and/or vibration damping, chemical resistance, temperature resistance and/or thermal shock resistance than the fast cure adhesive. Alternatively, these or other respective properties of the fast and slow cure adhesives may co-operate together synergistically, such as the slow cure adhesive having excellent mechanical strength and/or fracture toughness and the fast cure adhesive having excellent chemical resistance, for example when the fast cure adhesive is configured to surround the slow cure adhesive as a perimeter thereof. The volume of the slow cure adhesive within the bonded structure and/or the area of the slow cure adhesive in contact with at least one or all of the substrates may be larger than that of the fast cure adhesive, for example forming more than 50%, more than 75%, or more than 85% or 90% of the volume and/or contact surface area, 95% being one example.

FIGS. 2A to 2C show a modification of the embodiment of FIG. 1. The present inventor has noted that it is possible to change curing kinematics of two-component adhesives by changing the mix ratio between the two components. An excess of catalyst component 20 may be sprayed from nozzles 22 on to localised areas of the bead of the joint between the substrates 14, 16 in order to speed up cross linking just before closing the joint. Even though the modified mix ratio may affect the mechanical properties of the cured adhesive in the fast cured adhesive portion where the excess catalyst component 20 has been sprayed, this should not affect the overall joint performance at the bonded structure 10 due to the application of the catalyst component 20 only being local. As shown in FIGS. 2A to 2C, a robot first applies slow cured adhesive 12 to the substrate 16 as shown in FIG. 2A. The substrates 14, 16 are then moved to a position near assembly stations (not shown) and are placed in jigs (not shown). As shown in FIG. 2B, the excess catalyst component 20 is then sprayed through nozzles 22 on to localised areas of the slow cure adhesive 12, thereby forming localised regions or portions of what will become fast cure adhesive. As shown in FIG. 2C, the joint is then closed and the fast cure adhesive portions 18 in relatively small localised areas are cured while jigs (not shown) remain in place. The jigs (not shown) are then removed and the bonded structure 10 is moved on to the next station on a production line (not shown). This method has similar advantages to those described above with reference to FIG. 1, and may also have a further advantage in that only two types of adhesive component may needed to be sourced and applied, i.e. one of these being hardener or catalyst, some of which is applied in excess amounts by the spray nozzles 22 to form a relatively fast cure adhesive portion. The same nozzles 22 (i.e. all of the same dispensing equipment) may be used for applying both the excess hardener/catalyst component and the amount/ volume of hardener or catalyst used in the slow cure portion of the adhesive, thereby optimising manufacturing simplicity and cost.

As set out in FIG. 3, in another method in accordance with a preferred embodiment of the invention, substrates 14, 16 are assembled “dry” without the adhesive in place and a jig or mechanical fastener 24 is used to align the substrates 14, 16 correctly. Instead of using the mechanical fasteners or jig elements 24, these may be replaced (in a modified process) with a fast curing adhesive as described above with reference to FIGS. 1 and 2 or a fast curing adhesive may be used in addition to the mechanical fastenings 24. A nozzle 26 may then be introduced into an aperture 28 formed through one of the substrates 14 to introduce a layer of adhesive 30 between and so as to contact the substrates 14, 16. This aperture 28 may be a through-thickness gap or hole through one of the substrates (or may be replaced by a gap between the substrates at a position at the edge of the joint), subject to the geometry of the particular joint concerned. The geometry of the nozzle 26 may be adapted and designed so as to be appropriate for the particular joint geometry concern and the nozzle 26 may be heated and may be held in place relative to the substrates 14, 16 by a suction device (not shown). The adhesive 30 may be heated prior to injection. A vacuum or other pressure device may be applied in the region of the substrates 14, 16 in order to pull the adhesive through the joint cavity or gap 32 formed between the substrates 14, 16. One or both of the substrates 14, 16 may be provided with raised areas, such as ridges or spots in order to form a spacer (not shown) for spacing the gap distance of the joint cavity 32. The amount of adhesive 32 injected is controlled, either manually, by a technician, or by the amount of injection time, dependent for example upon temperatures, viscosities, pressures, suction forces, and relevant geometries at the substrates 14, 16 or the amount may be controlled automatically. The described process can be carried out either manually by a technician, for example during small scale production, or automatically by robots, for example during a mass production application. A method of sealing the joint, e.g. during injection, may be provided, such as a filler (not shown), a different adhesive (not shown) around or next to the adhesive 30, or a specially moulded joint geometry may serve this function. Accordingly, due to the way this method is carried out the squeeze-out of adhesive may be prevented. The amount of adhesive used may therefore be minimised and environmental procedures optimised. Furthermore, when a fast cure portion of adhesive is applied in the embodiment of FIG. 3, not only may production thereby be faster but the amount of adhesive used and environmental aspects may also be optimised.

In the various specific embodiments described above, careful attention is taken with regard to the control of conditions for specific geometry, adhesive combination, clean surfaces, and closing of joints before all adhesive has fully cured. In selecting the precise procedures to be used when carrying out at least some preferred embodiments of the invention, careful attention is taken with regard to adhesive formulations, including their speed of cure and viscosity, temperature (in some embodiments, for example, adhesives which only cure at above 120 degrees C. may be employed), surface preparation, the types of substrates used, such as whether they are metals such as anodised aluminium, aluminium alloys or composites, adhesive types, joint and nozzle geometries, pressures used, the joint sealing method and the amount of each adhesive and adhesive component which is applied.

It is envisaged that the skilled person in the art may make various changes to the embodiments specifically described above without departing from the scope of the invention.

1. A method of forming a bonded structure comprising:
providing a first substrate and a second substrate,
adding an adhesive region between the substrates, wherein the adhesive region has a first adhesive portion and a second adhesive portion, and
curing the first adhesive portion more quickly than the second adhesive portion.

2. A method as claimed in claim 1 in which the second adhesive portion is applied to at least one of the substrates before, substantially simultaneously with or after the first adhesive portion.

3. A method as claimed in claim 1 in which the second adhesive portion is formed over at least 50%, 75%, 85%, 90%, or 95% of the area of the adhesive region in contact with at least one of the substrates and/or the volume of adhesive applied.

4. A method as claimed in claim 1 in which the first and second adhesive portions have different chemical compositions to one another.

5. A method as claimed in claim 1 in which the first adhesive portion comprises an adhesive which is faster to cure than the second adhesive portion.

6. A method as claimed in claim 1 in which the first adhesive portion extends fully between the first and second substrates.

7. A method as claimed in claim 1 in which the first adhesive portion is formed by adding a catalyst component the second adhesive portion.

8. A method as claimed in claim 7 in which the catalyst component is added by spraying.

9. A method as claimed in claim 7 in which the first adhesive portion is formed in a localised area with the catalyst component to increase cross-linking and thereby the speed of cure in the localised area.

10. (canceled)

11. A method as claimed in claim 1 further comprising moving the bonded structure once the first adhesive portion is substantially cured, so that relative movement between the first and second substrates does not easily occur during the moving.

12. A method as claimed in claim 1 further comprising moving the bonded structure before the second adhesive portion has completed curing.

13. A method as claimed in claim 1 in which the second adhesive portion has at least one performance parameter superior to the first adhesive portion.

14. A method as claimed in claim 13 in which the performance parameter is one or more of ultimate tensile strength, Young's modulus, yield strength, compressive strength, impact strength, fracture toughness, fatigue performance, vibration resistance and/or damping, chemical resistance, high or low temperature resistance and thermal shock resistance.

15. A method of forming a bonded structure comprising
providing a first substrate and a second substrate, and
positioning the substrates relative to one another, applying adhesive to surfaces of the substrates by injecting the adhesive between the surfaces of the substrates to form an adhesive region while holding the substrates relative to one another.

16. A method as claimed in claim 15 further comprising stopping the injecting before or at a point at which the adhesive would be squeezed out from between the first and second substrates.

17. A method as claimed in claim 1 further comprising holding one or both of the first and second substrates in a jig while the adhesive region is applied.

18. A method as claimed in claim 15 further comprising holding the first and second substrates spaced apart in a fixed configuration relative to one another with a gap therebetween and injecting the adhesive region into the gap.

19. A method as claimed in claim 15 in which at least one of the first and second substrates has a substantially flat surface at the adhesive region to which the adhesive region is applied.

20. A method as claimed in claim 19 in which the first and second substrates each have a substantially flat surface, in which the substantially flat surfaces are parallel to one another and spaced apart by a gap which is at least partially filled by the adhesive region, and in which the adhesive region extends between and contacts the substantially flat surfaces of the substrates.

21. A method as claimed in claim 20 in which the gap is about 1 mm to 10 mm in distance between the substrates.

22. A method as claimed in claim 15 further comprising injecting at least part of the adhesive region through a hole formed through one of the substrates or into a gap between the substrates at an edge region thereof.

23. A method as claimed in claim 15 further comprising applying at least part of the adhesive of the adhesive region through a nozzle.

24. A method as claimed in any claim 23 further comprising holding the nozzle in place while adhesive is applied through it.

25. A method as claimed in claim 15 further comprising heating at least part of the adhesive of the adhesive region prior to application to the surfaces of the substrates.

26. A method as claimed in claim 1 in which each adhesive portion comprises a two-part adhesive comprising resin and hardener.

27. A method as claimed in claim 1 further comprising applying a vacuum around at least part of the adhesive region.

28. (canceled)

29. A method as claimed in claim 5 further comprising configuring the first adhesive portion as a perimeter into the inside of which the second adhesive portion is injected.

30. A method as claimed in claim 1 further comprising using the first adhesive portion as a seal around the second adhesive portion to prevent leakage while the second adhesive portion cures.

31. A method as claimed in claim 1 further comprising applying the first adhesive portion as individual and mutually spaced apart zones or blobs.

32. A method as claimed in claim 1 in which at least one of the substrates is a metal material composite material, or a plastic material.

33. (canceled)

34. A bonded structure comprising a first substrate and a second substrate bonded together by an adhesive region, wherein the adhesive region includes a first adhesive portion and a second adhesive portion, the first adhesive portion containing faster cure adhesive than the second adhesive portion.

35. (canceled)

36. (canceled)

37. (canceled)

38. (canceled)
